(19) United States
(12) Patent Application Publication
(10) Pub. No.: US 2014/0016988 A1
(43) Pub. Date: Jan. 16, 2014

(54) UNIT DOSE SYSTEM

(71) Applicant: Team Technologies, Inc., Morristown, TN (US)

(72) Inventors: Clark F. Bow, Dandridge, TN (US); Steven R. Henrikson, Morristown, TN (US)

(21) Appl. No.: 13/910,631

(22) Filed: Jun. 5, 2013

Related U.S. Application Data
(60) Provisional application No. 61/669,794, filed on Jul. 10, 2012.

(51) Int. Cl. A61J 3/00

(52) U.S. Cl. CPC A61J 3/00
USPC 401/206; 401/205

(57) ABSTRACT

A liquid dispensing system having a reservoir, a flow through applicator having a bore in flow communication with the reservoir, an applicator mount for mounting the applicator on the reservoir, a removable seal for sealing liquid from escaping the dosing system. A flow restrictor may be incorporated located within a portion of the bore of the applicator to control the flow rate and hence the dosing or application rate of the liquid from the reservoir. Alternatively, or in conjunction with the flow restrictor, a plunger is included within the reservoir to be moved forward when the user squeezes the reservoir to urge liquid in the reservoir from the reservoir.

### CROSS-REFERENCE TO RELATED APPLICATION

This application claims priority to U.S. Provisional Application Ser. No. 61/669,794 filed Jul. 10, 2012, and entitled UNIT DOSE SYSTEM, incorporated by reference herein in its entirety.

### FIELD

This disclosure relates to the field of liquid applicators. More particularly, this disclosure relates to liquid dosing systems incorporating a flow resistor for controlling the application rate of liquid, or an internal plunger system for expelling liquid, or both.

### BACKGROUND

Improvement is desired in the construction of fluid, and in particular, liquid dispensers. In particular, improvement is desired in the construction of disposable single dose applicators of the type used for applying liquid dental care products such as tooth whitening preparations. These applicators may also be suitable for applying other liquids, including cosmetics such as fingernail polish, eyeliner, mascara, and lip gloss.

In particular, what is desired is a manner of construction that enables improved control over the flow rate of the liquid being applied. Conventional applicators are prone to liquid flowing from the applicator in excess of a desired rate, resulting in undesirable application characteristics.

The present disclosure relates in one aspect to an improved liquid dispensing system having a flow resistor that enables desirable application of liquid to a surface.

Another shortcoming of conventional liquid dispensers relates to wholly voiding the contents of the dispensers. For example, dental varnish is a highly viscous fluid containing fluoride. The viscosity of the fluid makes it difficult to wholly dispense from a dispenser without leaving a considerable quantity remaining in the dispenser. However, as the fluoride is a controlled substance, the amount provided in the dispenser cannot simply be increased to ensure a sufficient amount of varnish will be dispensed.

In another aspect, the present disclosure relates to an internal plunger system that facilitates voiding of the dispenser, and which may be used in conjunction with the flow resistor if desired.

### SUMMARY

The disclosure relates to liquid dispensing systems.

In one aspect, a dispensing system according to the disclosure includes a reservoir formed of a pliable liquid impermeable material for holding a quantity of liquid to be dispensed by the system; a flow through applicator having a bore in flow communication with the reservoir for passage of liquid from the reservoir through the bore; an applicator mount for mounting the applicator on the reservoir; and a flow restrictor located within a portion of the bore of the applicator to control the flow rate and hence the dosing or application rate of the liquid from the reservoir. The flow restrictor defines a plurality of flow channels for flow of liquid to be dispensed by the system.

In another aspect, a dispensing system according to the disclosure includes a reservoir formed of a pliable liquid impermeable material for holding a quantity of liquid to be dispensed by the system; a flow through applicator having a bore in flow communication with the reservoir for passage of liquid from the reservoir through the bore; an applicator mount for mounting the applicator on the reservoir; and an internal plunger located within the reservoir. The plunger is configured for being engaged by a user exerting a squeezing force on the reservoir. The plunger is movable by the squeezing force to contact and urge liquid in the reservoir from the reservoir through the applicator.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 shows a self-contained liquid dosing system according to the disclosure.

FIG. 2 is a perspective view of a self-contained liquid dosing system according to the disclosure.

FIG. 3 is a cross-sectional view of the dosing system of FIG. 2.

FIG. 4 is an exploded perspective view showing the components of the dosing system of FIG. 2.

FIG. 5 is a perspective view showing the dosing system of FIG. 2 with a seal component thereof removed for permitting liquid to be applied using the dosing system.

FIG. 6 is a perspective view of a reservoir component of the dosing system of FIG. 2 prior to assembly of the system.

FIGS. 7A, 7B, and 7C are perspective views of a flow restrictor component of the dosing system of FIG. 2.

FIGS. 8A, 8B, 8C, and 8D are perspective views of an applicator component of the dosing system of FIG. 2.

FIGS. 9A and 9B are perspective views of a one-piece mount and seal component of the dosing system of FIG. 2; and FIG. 9C is a cross-sectional view thereof.

FIG. 10 is a perspective view of a liquid dispenser in accordance with a further embodiment of the disclosure having an internal plunger system.

FIG. 11 is an exploded perspective view of the liquid dispenser of FIG. 10.

FIGS. 12 and 13 are cross-sectional side views of the liquid dispenser of FIG. 10 showing operation of the internal plunger system.

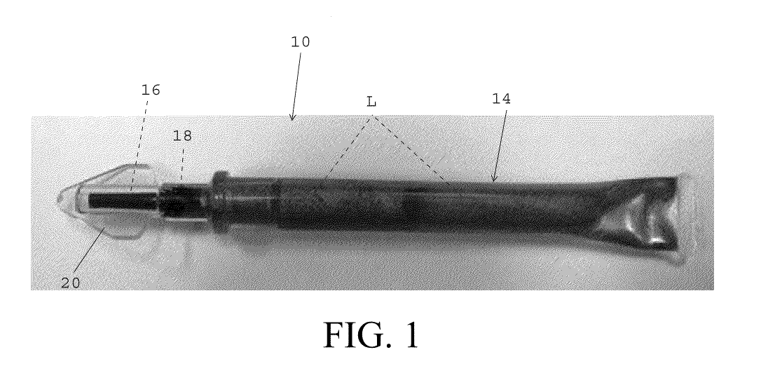

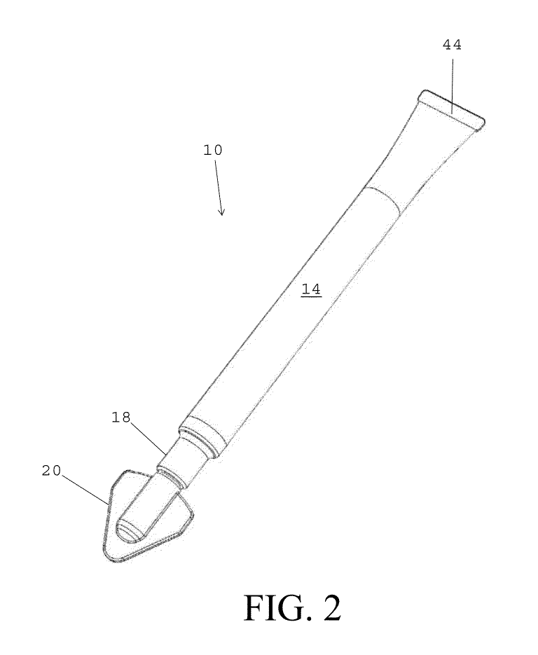

### DETAILED DESCRIPTION

With reference to the drawings, in one embodiment the disclosure relates to a self-contained liquid dosing system 10 having a flow restrictor 12 incorporated therewith to control the flow rate and hence the dosing or application rate of a liquid L to a surface. The dosing system 10 also includes a reservoir 14, an applicator 16 in flow communication with the reservoir 14, an applicator mount 18 for mounting the applicator on the reservoir 14, and a removable seal 20 for sealing liquid from escaping the dosing system 10.

The liquid dosing system 10 is particularly configured for single application use purposes, however, it will be understood that the system could be configured for multiple applications. Thus, in the context of a single application use, the volume of the liquid L to be loaded to the reservoir 14 will correspond to an appropriate single use dose.

The flow restrictor 12 is configured to reduce the flow path of liquid traveling from the reservoir 14 to the applicator 16 and is preferably of one-piece molded plastic construction having a base 30 from which extends an elongate guide 32 defining along its length a plurality of flow channels 34a, 34b, and 34c. The guide 32 is centrally located at a distal end of the base 30 and has a cross-sectional dimension that is substantially smaller than the cross-sectional dimension of the base 30. The flow channels 34a-34c are preferably uniformly spaced apart about the periphery of the guide 32. The base 30 preferably includes a plurality of shoulders 36a, 36b, and 36c, which provide a smooth transition and flow path between the base 30 and the guide 32. The flow restrictor 12 is shown with the base 30 being substantially triangular in cross-section and there being three channels, with each channel being substantially along the midpoint of one of the sides of the base 30.

The reservoir 14 may be provided as by a flexible or pliable liquid impermeable material, such as a flexible plastic. In a preferred embodiment, the reservoir 14 is provided as a tube 40 having opposite open ends 42a and 42b. The tube 14 may be loaded with a desired liquid, such as fingernail polish, dental preparation, and the like, to be dispensed using the system 10. After the tube is loaded with the desired liquid, the end 42b is sealed as by flattening and heat sealing to provide a closed end 44 preferably having a flattened configuration. The liquid L is forced out of the reservoir 14 as by squeezing the reservoir 14 and forcing the liquid L to exit via the applicator 16 as restricted by the flow restrictor 12 once the seal 20 had been removed.

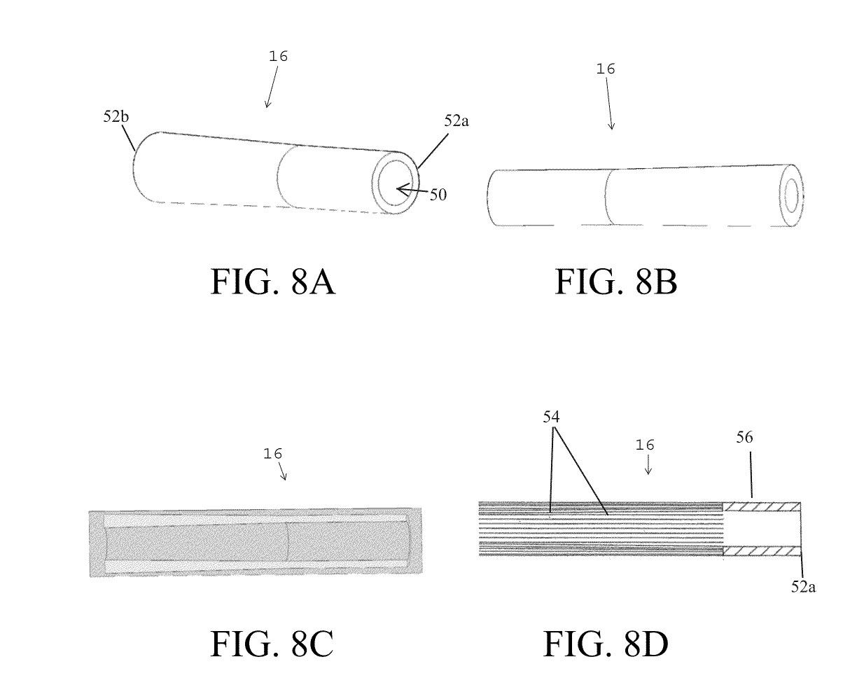

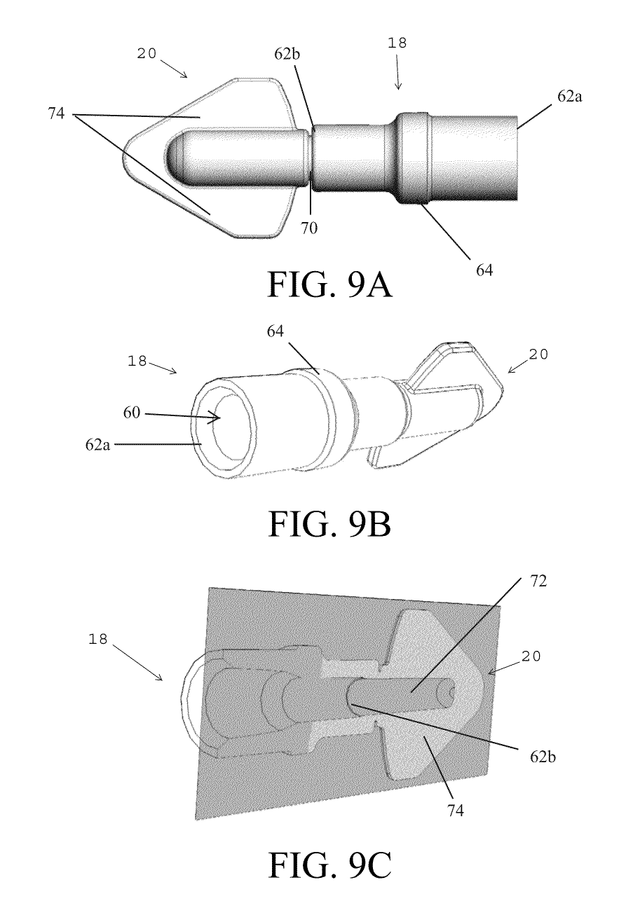

The applicator 16 is a flow through type applicator characterized as an elongate cylinder having a central bore 50 and opposite open ends 52a and 52b. The applicator 16 may be formed, for example, by a plurality of longitudinally aligned bristles 54 (FIG. 8). A lower portion 56 of the bristles 54 adjacent the end 52a, which is the end of the applicator 16 received in the mount 18, are desirably fused together. A brush type applicator made of nylon bristles and suitable for providing the applicator 16 is described in U.S. Pat. No. 6,854,914, issued Feb. 15, 2005, entitled FLOW-THROUGH BRUSH LIQUID APPLICATOR AND METHOD OF MAKING, and incorporated herein by reference in its entirety. It will be understood that the applicator 16 may be of various configurations and made of various materials, including foams and bristles.

The applicator mount 18 is of one-piece molded plastic construction and is generally characterized as an elongate cylinder having a central bore 60 and opposite open ends 62a and 62b. The bore 60 is sized to fittingly receive the portion 56 of the applicator 16, with the flow restrictor 12 therein. The end 62a is sized to sealingly fit into the distal open end 42a of the reservoir 14 so that a collar 64 on the mount 18 abuts the exterior of the open end 42a of the reservoir 14. The mount 18 may be sealed to the reservoir 14 as by heat sealing, adhesive, or the like. The mount 18 is shown molded to include the seal 20, with the seal 20 thereafter being removed to expose the applicator 16 and permit liquid to be applied to a surface using the applicator 16.

The seal 20 is preferably co-formed with the mount and removable as by breaking off from the mount 18 at the end 62b of the mount 18. In this regard, a thin break point 70 is preferably defined between the mount 18 and the seal 20 and the seal 20 is not re-attachable to the mount 18. This is desirable for manufacture of a single use dosing system 10. Alternatively, the seal 20 may be configured to be reattached to the mount or be separately molded and threadably received by the mount 18 or the like. The seal 20 is configured to include an interior bore 72 sized to fit over the portion of the applicator 16 that extends past the mount 18. To facilitate grasping and twisting of the seal 20 to remove it from the mount 18, a flat fin 74 is defined on the exterior of the seal 20 to provide a surface for grasping and leverage. Also, for ease of packaging, the fin 74 is desirably oriented in alignment with the flattened closed end 44 of the reservoir 14.

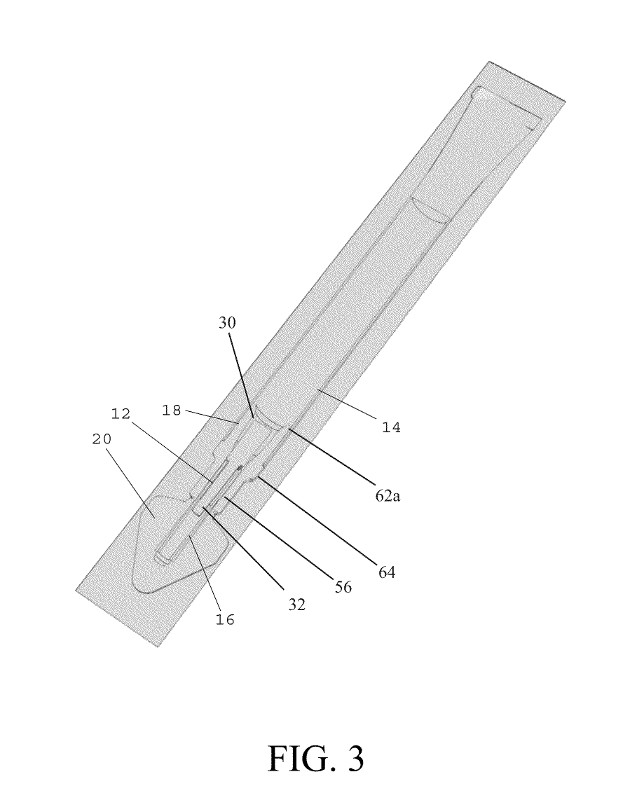

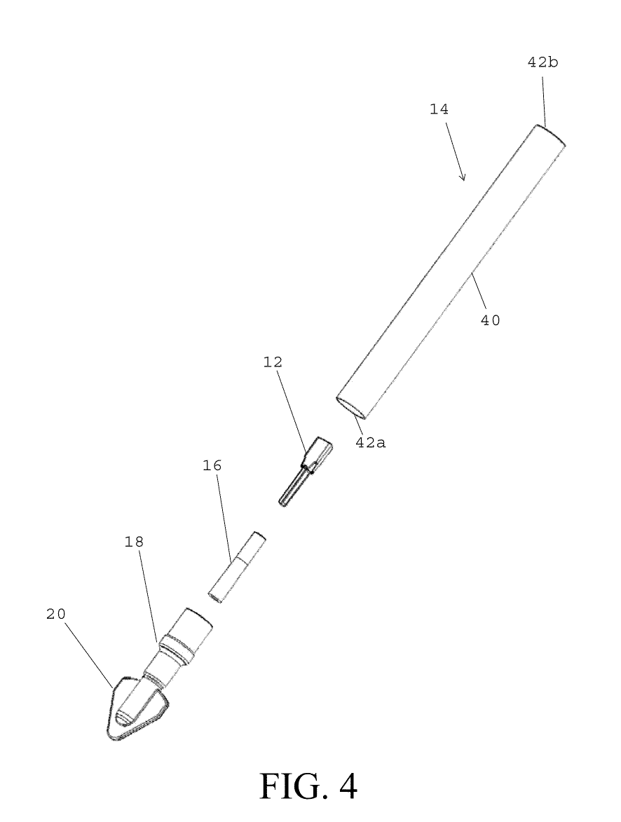

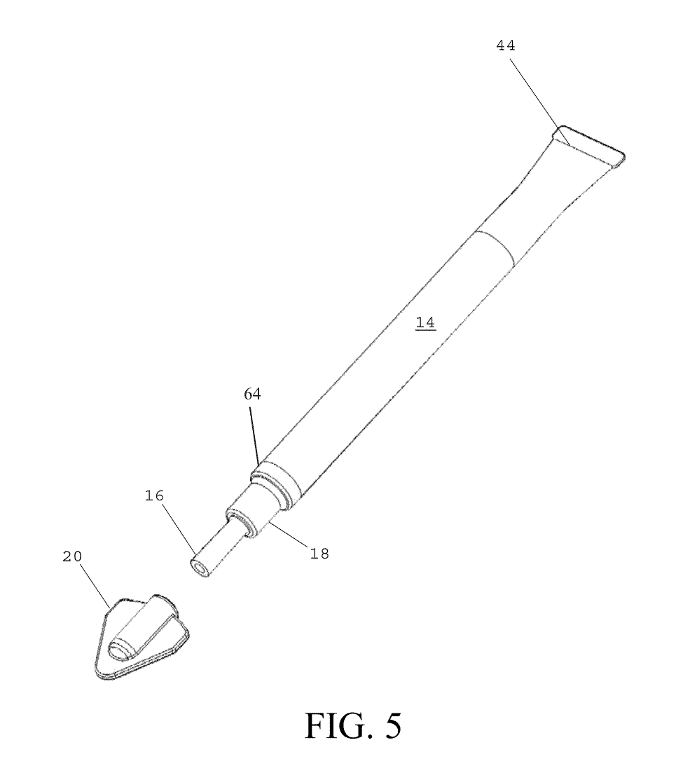

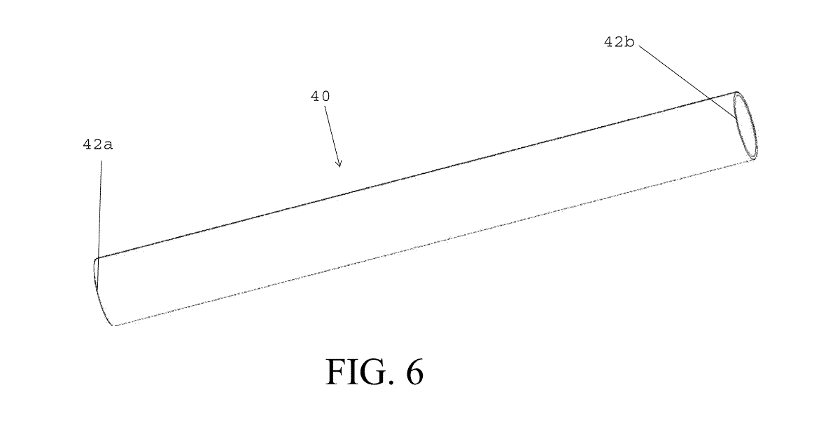

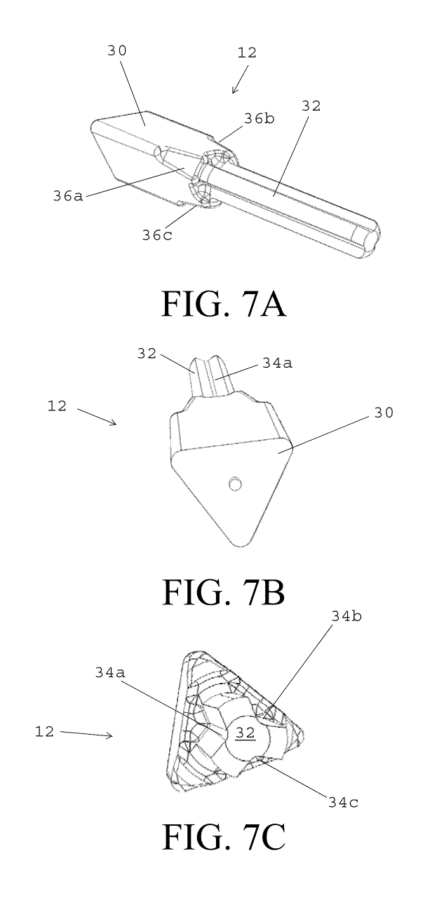

In the assembled system 10, as seen in FIG. 3, the guide 32 of the restrictor 12 preferably extends into the lower portion 56 of the bristles 54 so as to restrict the bore 50 of the applicator 16. The restrictor 12 within the bore 50 of the applicator 16 preferably reduces the total cross sectional area of the flow path by about 50 percent. For example, the bore 50 may have a diameter of about 0.080 inches, yielding a cross sectional flow area of about 0.005026 square inches. For this size bore of the applicator 16, the guide 32 desirably occupies a cross-sectional area of about 0.002579 square inches. With the restrictor 12 in place, the flow path is divided into three segments by the channels 34a-34c, and the depth of each of the channels 32a-32c is preferably about 0.017 inches. Accordingly, the flow path is restricted by about 50 percent, but the surface area over which the flow of liquid is exposed as provided by the channels 32a-32c that the fluid is in contact with is increased by about 12 percent.

In this regard, it has been observed that forcing the liquid L through multiple thin channels increases resistance to flow versus the resistance provided by a single bore or path with the same total flow path. The liquid that wets out the walls of the flow path is essentially not moving while the liquid in a path furthest from any wall moves at the highest velocity at any given pressure. Thus, in this case, the distance from the interior wall to the center of the flow path is about 0.008 inches, with restrictor 12 in place versus about 0.04 inches absent the restrictor 12.

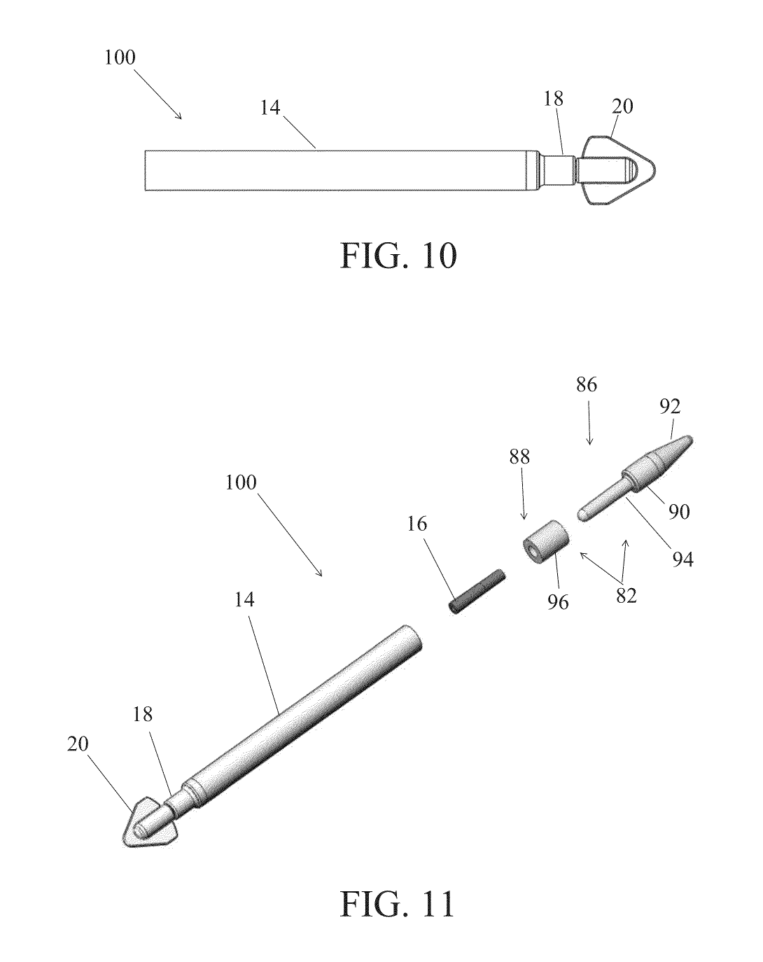

Turning now to FIGS. 10-13, there is shown another embodiment of a self-contained liquid dosing system 80. The liquid dosing system 80 is substantially identical to the system 10 in terms of its components, except, it optionally may or may not include the flow restrictor 12, but does include an internal plunger system 82. Accordingly, the dosing system 80 includes components corresponding to the reservoir 14, the applicator 16, the mount 18, and the seal 20 described above in connection with the dosing system 10.

The plunger system 82 may be used with the flow restrictor 12, or without the flow restrictor 12. In this regard, the flow restrictor 12 is particularly desirable for use with relatively low viscosity liquids. In the case of higher viscosity liquids which do not tend to flow freely out of the dosing systems according to the disclosure, it may be desirable to omit the flow restrictor 12. However, especially in the case of higher viscosity fluids, such fluids may be difficult to substantially wholly void from the reservoir 14. The plunger system 82 desirably facilitates voiding of liquids from the reservoir 14, and is especially desired in the case of higher viscosity liquids. However, it will be understood that the plunger system 82 may also be used with lower viscosity fluids and may be used in conjunction with the flow restrictor 12.

The internal plunger system 82 includes a plunger 86 movably located, such as by sliding, within the reservoir 14 and having a piston 88 located thereon. The plunger system 82 functions to force liquid from the reservoir 14 and to wipe the interior surfaces of the reservoir 14 to enable substantial voiding of the reservoir 14 so that residual liquids do not remain following a dosing operation to remove liquid from the reservoir 14.

The plunger 86 may be provided by an elongate, preferably one-piece body made of a rigid material, such as a rigid plastic. The plunger 86 includes a major dimension 90, generally located proximate a central portion of the plunger 86, sized to loosely engage the interior surfaces of the reservoir 14. A rear portion 92 of the plunger 86 is preferably tapered to provide a surface that facilitates a user squeezing the reservoir 14 and urging the plunger 86 forward. A forward portion 94 extends from the major dimension 90 and is of reduced dimension so as to be able to fit within the reduced dimension of the mount 18 and void liquids in the forward portions of the dosing system 80. In this regard, the forward portion 94 of the plunger 86 preferably has a length sufficient to seat the piston 88 and have a sufficient leading portion fully extend into the mount 18 (FIG. 13).

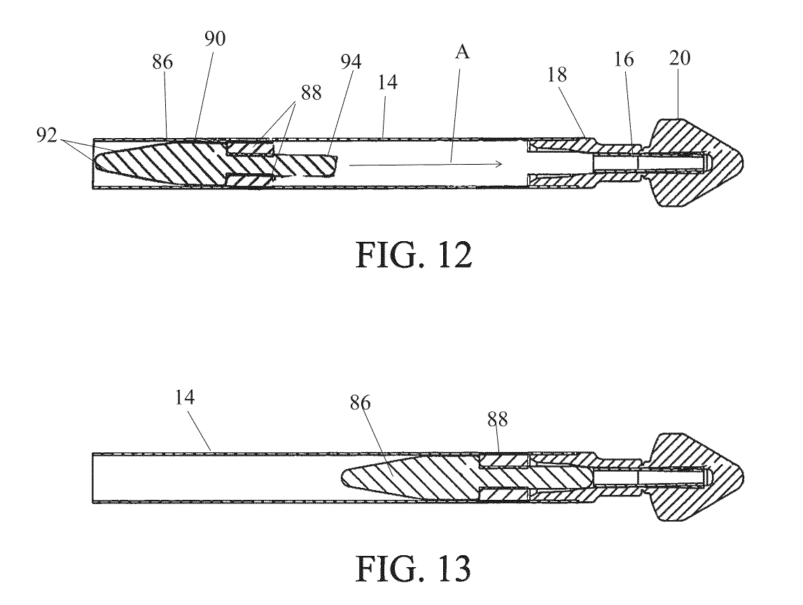

The piston 88 may be provided as by a cannulated cylindrical pliable material, such as closed cell foam shaped as by die cutting techniques. The piston 88 includes a sidewall 96 having an outer dimension sized to engage the interior surfaces of the reservoir 14. The piston 88 also includes a central bore 98 configured to enable the piston 88 to be seated on the forward portion 94 of the plunger 86. The sidewall 96 of the piston provides a contacting surface to wipe the interior surfaces of the reservoir 14 as the plunger travels in the direction of an arrow A from an original location at the rear of the reservoir 14 (FIG. 12) to the front of the reservoir 14 (FIG. 13). In certain embodiments, the major diameter 90 of the plunger 86 may provide the contacting surface to wipe the interior sufaces of the reservoir 14.

The plunger 86 with the piston 88 mounted thereon is located at the rear of the reservoir 14 and oriented with the forward portion 94 closest to the applicator 16. The liquid to be dispensed is desirably forward of the piston 88, with the piston 88 and the forward portion of the plunger 94 substantially inhibiting liquid from passing rearward of the piston 88. As liquid is dispensed from the dosing system 80, the plunger system 82 may be utilized, as by squeezing the rear portion 92 thereof through the reservoir 14, to move the plunger 86 forward and push the liquid in the reservoir towards and through the applicator 16.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A liquid dispensing system, comprising:
a reservoir formed of a pliable liquid impermeable material for holding a quantity of liquid to be dispensed by the system;
a flow through applicator having a bore in flow communication with the reservoir for passage of liquid from the reservoir through the bore;
an applicator mount for mounting the applicator on the reservoir; and
a flow restrictor located within a portion of the bore of the applicator to control the flow rate and hence the dosing or application rate of the liquid from the reservoir, the flow restrictor defining a plurality of flow channels for flow of liquid to be dispensed by the system.

2. The system of claim 1, wherein the flow restrictor has a base from which extends an elongate guide defining along its length the plurality of flow channels.

3. The system of claim 2, wherein the guide defines at least three flow channels.

4. The system of claim 1, wherein the bore of the applicator has a first surface areas and the flow restrictor defines a second surface area over which the flow of liquid is exposed, with the second surface area being greater than the first surface area.

5. The system of claim 1, further comprising a removable seal for sealing liquid from escaping the dosing system.

6. The system of claim 1, further comprising an internal plunger system located within the reservoir, the plunger system being configured for being engaged by a user exerting a squeezing force on the reservoir, the plunger system being movable by the squeezing force to contact and urge liquid in the reservoir from the reservoir through the applicator.

7. A liquid dispensing system, comprising:
a reservoir formed of a pliable liquid impermeable material for holding a quantity of liquid to be dispensed by the system;
a flow through applicator having a bore in flow communication with the reservoir for passage of liquid from the reservoir through the bore;
an applicator mount for mounting the applicator on the reservoir; and
an internal plunger system located within the reservoir, the plunger system being configured for being engaged by a user exerting a squeezing force on the reservoir, the plunger system being movable by the squeezing force to contact and urge liquid in the reservoir from the reservoir through the applicator.

8. The liquid dispensing system of claim 7, further comprising a removable seal for sealing liquid from escaping the dosing system.

9. The liquid dispensing system of claim 7, wherein the plunger system includes a substantially rigid plunger and a pliable member.

10. The liquid dispensing system of claim 9, wherein the reservoir includes interior surfaces and the pliable member is substantially cylindrical with a sidewall that acts as a contact surface to wipe the interior surfaces of the reservoir as the plunger moves.

11. The liquid dispensing system of claim 10, wherein the pliable member includes a central bore configured to enable the pliable member to be seated on a forward portion of the plunger.

12. The liquid dispensing system of claim 7, wherein the reservoir includes interior surfaces and the plunger system includes a contact surface to wipe the interior surfaces of the reservoir as the plunger moves.

13. The liquid dispensing system of claim 7, further comprising a flow restrictor located within a portion of the bore of the applicator to control the flow rate and hence the dosing or application rate of the liquid from the reservoir, the flow restrictor defining a plurality of flow channels for flow of liquid to be dispensed by the system.
